(19) United States
(12) Patent Application Publication
(10) Pub. No.: US 2026/0243465 A1
(43) Pub. Date: Aug. 20, 2026

(54) HEAT EXCHANGER AND WATER HEATING APPARATUS HAVING SAME

(71) Applicant: KYUNGDONG NAVIEN CO., LTD., Gyeonggi-do (KR)

(72) Inventor: Ryou Keun KIM, Seoul (KR)

(73) Assignee: KYUNGDONG NAVIEN CO., LTD., Gyeonggi-do (KR)

(21) Appl. No.: 18/995,221

(22) PCT Filed: Jul. 20, 2023
(86) PCT No.: PCT/KR2023/010494

§ 371 Date: Jan. 16, 2025

(30) Foreign Application Priority Data
Aug. 12, 2022 (KR) 10-2022-0101486
Jun. 30, 2023 (KR) 10-2023-0085303

(51) Int. Cl. F24H 9/1818; F24H 1/12; H05B 3/06

(52) U.S. Cl. CPC F24H 9/1818; F24H 1/12; H05B 3/06; H05B 2203/021

(57) ABSTRACT

The present invention relates to a heat exchanger and a water heating apparatus having same. The heat exchanger according to an embodiment of the present invention comprises: a heating member including a heating pattern of a predetermined shape and generating heat; and a body part in which, while water flowing in through an inlet part flows to an outlet part along a flow path, heat exchange takes place due to the heat generated by the heating member to generate and discharge hot water, wherein the heating pattern is divided into a plurality of sections formed to have different widths from one another.

### TECHNICAL FIELD

### Cross-Reference to Related Application

This application claims the benefit of priority to Korean Patent Application Nos. 10-2022-0101486 and 10-2023-0085303, filed in the Korean Intellectual Property Office on Aug. 12, 2022 and Jun. 30, 2023, respectively, the entire contents of which are incorporated herein by reference.

### TECHNICAL FIELD

The present disclosure relates to a heat exchanger and a water heating apparatus having the same, and more particularly to a technology for preventing scales from being generated in a heat exchanger by adjusting a heating pattern of a heating member that provides heat for heating water containing calcium ions.

### BACKGROUND ART

In general, devices using electric boilers and water heaters directly heat water that contains minerals, such as calcium and magnesium ions.

Accordingly, when water containing minerals is directly heated and used in electric boilers and water heaters, calcium ions contained in the water may be deposited as calcium carbonate to generate scales that are fixed in an interior of a flow path.

In this way, when scales are generated in an interior of the flow path, the flow of the water that flows along the flow path may be obstructed, and thus, a heat exchange performance may decrease and heating emitting elements may deteriorate, and thus, a life span of the device may be shortened.

Conventionally, to suppress generation of scales, generation of scales is suppressed by removing calcium ions that cause generation of scales by using an ionization filter or the like to lower a concentration of calcium ions.

However, the costs increase because additional facilities, such as ionization filters, have to be separately provided, and a space for installing additional facilities has to be secured.

### DISCLOSURE

### Technical Problem

An aspect of the present disclosure provides a heat exchanger and a water heating apparatus having the same that may prevent scales from being generated in a flow path of the heat exchanger by decreasing a pow density of a heating pattern to suppress a surface temperature of water from continuously rising.

An aspect of the present disclosure also provides a heat exchanger and a water heating apparatus having the same that decreases a power density step by step by forming a width of the heating pattern for each of subdivided sections by subdividing the heating pattern such that the width becomes gradually larger.

An aspect of the present disclosure also provides a heat exchanger and a water heating apparatus having the same that may prevent an increase in costs due to additional facilities by adjusting a width of a heating pattern to suppress a surface temperature of water in a flow path from continuously rising.

The technical problems to be solved by the present disclosure are not limited to the aforementioned problems, and any other technical problems not mentioned herein will be clearly understood from the following description by those skilled in the art to which the present disclosure pertains.

### Technical Solution

According to an aspect of the present disclosure, a heat exchanger includes a heating member including a heating pattern of a predetermined shape, the heating pattern being configured to generate heat, and a body part configured to exchange the heat generated by the heating member to generate and discharge hot water while water introduced through a water inlet flows to a water outlet along a flow path, and the heating pattern is divided into a plurality of sections, and is formed such that widths of the heating pattern are different for the divided sections.

According to an embodiment, the heating pattern may be formed along a flow direction of the water flowing along the flow path.

According to an embodiment, the heating pattern may be formed in a zigzag shape.

According to an embodiment, the body part may include an upper panel, in which the water inlet and the water outlet are formed, a lower panel coupled to the upper panel at a lower portion of the upper panel, and a flow path panel, in which the flow path is formed, and formed to be adhered between the upper panel and the lower panel when the upper panel and the lower panel are coupled to each other, and the flow path panel may be formed such that ends of the flow path is connected to the water inlet and the water outlet.

According to an embodiment, the heating member may be formed to be adhered to an upper portion of the upper panel, and between the water inlet and the water outlet.

According to an embodiment, the heating pattern may be formed such that the widths of the heating pattern become gradually larger as they go from the water inlet connected to the flow path to the water outlet.

According to an embodiment, the heating pattern may be formed such that the widths of the heating pattern become gradually larger for the divided sections, and the widths of the heating pattern are the same in the same section.

According to an embodiment, the heating pattern may be formed such that power densities thereof decrease as they go from the water inlet connected to the flow path of the heat exchanger to the water outlet, for the divided sections.

According to an embodiment, the heating pattern may include a plurality of resistors, and the plurality of resistors is connected in a series structure.

According to an embodiment, the heating pattern may include a plurality of resistors, and the plurality of resistors is connected in a parallel structure.

According to an embodiment, the heating pattern may include a plurality of resistors, and the plurality of resistors is connected in a combined structure of series and parallel structures.

According to an embodiment, the heating pattern may include a plurality of resistors, and the plurality of resistors is connected in a combined structure of parallel structures.

According to an embodiment, the heating member may further include an insulation pad formed to be attached to an upper portion and a lower portion of the heating pattern.

According to another aspect of the present disclosure, there is provided a water heating apparatus including the heat exchanger.

### Advantageous Effects

According to an embodiment of the present disclosure, scales may be prevented from being generated in a flow path of the heat exchanger by decreasing a power density of a heating pattern to suppress a surface temperature of water from continuously rising.

Furthermore, according to an embodiment of the present disclosure, a power density may be decreased step by step by forming a width of the heating pattern for each of subdivided sections by subdividing the heating pattern such that the width becomes gradually larger.

In addition, according to an embodiment of the present disclosure, an increase in costs due to additional facilities may be prevented by adjusting a width of a heating pattern to suppress a surface temperature of water in a flow path from continuously rising.

### DESCRIPTION OF DRAWINGS

FIGS. 1A and 1B are views illustrating a structure of a heat exchanger according to an embodiment of the present disclosure.

FIG. 2 is a view illustrating a configuration of a heating member according to an embodiment of the present disclosure.

FIG. 3 is a view illustrating an embodiment of subdividing a heating pattern of a heating member for each section according to an embodiment of the present disclosure.

FIGS. 4A and 4B are views illustrating a structure of a heating pattern according to a first embodiment of the present disclosure.

FIGS. 5A, 5B, and 5C are views illustrating a structure of a heating pattern according to a second embodiment of the present disclosure.

FIGS. 6A, 6B, and 6C are views illustrating a structure of a heating pattern according to a third embodiment of the present disclosure.

FIGS. 7A, 7B, and 7C are views illustrating a structure of a heating pattern according to a fourth embodiment of the present disclosure.

FIG. 8 is a view illustrating a change in a state of a heat exchanger according to an embodiment of the present disclosure.

FIG. 9 is a view illustrating a configuration of a water heating apparatus according to an embodiment of the present disclosure.

### MODE FOR INVENTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

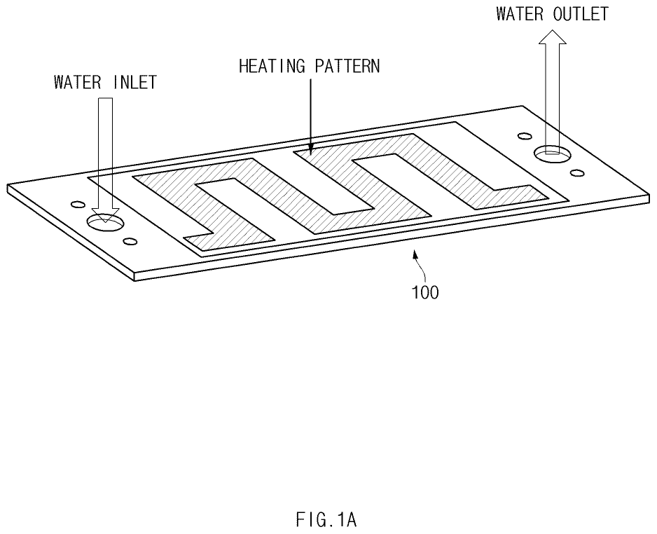

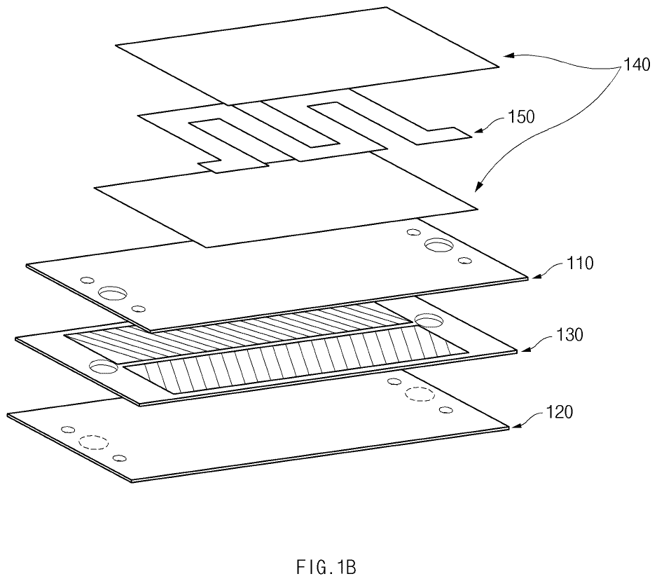

FIGS. 1A and 1B are views illustrating a detailed structure of a heat exchanger according to an embodiment of the present disclosure. Referring to FIGS. 1A and 1B, a heat exchanger 100 may include a body part and a heating member, and the components may be formed in a stacked structure. Here, the body part serves to generate and discharge hot water after exchanging heat with heat that is generated by the heating member while water introduced through a water inlet flows to a water outlet along a flow path.

Accordingly, the body part may be formed by coupling an upper panel 110, a lower panel 120, and a flow path panel 130.

The upper panel 110 and the lower panel 120 are formed in a plate structure, and a lower portion of the upper panel 110 and an upper portion of the lower panel 120 may be adhered to each other with the flow path panel 130 being interposed therebetween. In this case, the upper panel 110 is formed with a groove that is recessed in an upward direction, and the lower panel 120 is formed with a groove that is recessed in a downward direction, so that when the upper panel 110 and the lower panel 120 are coupled to each other, a space, in which the flow path panel 130 may be inserted, may be formed inside.

The flow path panel 130 may be formed in a plate-shaped structure, in which the flow path is formed. The flow path panel 130 may be inserted between the upper panel 110 and the lower panel 120 when the upper panel 110 and the lower panel 120 are coupled to each other, and an upper portion of the flow path panel 130 may be adhered to the upper panel 110, and a lower portion thereof may be adhered to the lower panel 120.

A water inlet 111, through which the water is introduced, may be formed on one side of the upper panel 110, and a water outlet 115, through which the water is discharged, may be formed on an opposite side thereof. Then, the flow path formed in the flow path panel 130 may have one end that is connected to the water inlet 111 and an opposite end that is connected to the water outlet 115. Accordingly, when water is introduced into an interior of the body part of the heat exchanger through the water inlet 111, the introduced water may flow along the flow path and may be discharged through the water outlet 115.

Here, the flow path may be formed with a long length, by which a heat exchange area may be maximized in a limited volume of the body part to maximize a heat emission capacity and efficiency while minimizing the volume of the heat exchanger 100. The flow path may be continued while having a pattern that maximizes a length from one end connected to the water inlet 111 to an opposite end connected to the water outlet 115. As an example, the flow path may be formed to have a zigzag pattern, but is not limited thereto.

The upper panel 110 and the lower panel 120 may be formed of a material having a thermal conductivity of a predetermined value or more. As an example, the upper panel 110 and the lower panel 120 may be formed of a metal material, but are not limited thereto.

The heating member may be disposed to contact an upper portion of the upper panel 110. In an embodiment of the present disclosure, an embodiment, in which the heating member is disposed to contact the upper portion of the upper panel 110, is described, but is not limited thereto, and may be disposed to be contact a lower portion of the lower panel 120.

The heating member includes a heating pattern 150, and an insulation pad 140 may be formed to adhere to an upper portion and a lower portion of the heating pattern 150. Here, the insulation pad 140 may be a plate-shaped pad that is coated with an insulating material or composed of an insulating material.

The heating pattern 150 may consist of a plurality of resistors. For example, the heating pattern 150 may be formed through printing. At this time, the plurality of resistors may be connected in a series structure or a parallel structure, and may be connected in a structure, in which a series structure and a parallel structure are combined. At both ends of the heating pattern 150 are connected to electrodes, respectively, and heat is generated when electric power is applied through the electrodes. Here, the heating pattern may be a surface heat emitter, but is not limited thereto.

The heat generated through the heating pattern 150 of the heating member is transferred to the flow path through the upper panel 110 that contacts the heating member. Accordingly, while the water introduced into the interior the body part of the heat exchanger 100 flows along the flow path, heat is exchanged by using the heat transferred by the heating member such that temperature rises, and then, the heated water is discharged through the water outlet 115.

A surface temperature of the heating pattern 150 of the heating member continuously rises when electric power is supplied through the electrodes. In this way, when the surface temperature of the heating pattern 150 continues to rise, a surface temperature of the water that flows along the flow path also continues to rise, and as the surface temperature of the water rises, scales are created as calcium ions contained in the water are deposited as calcium carbonate, and this may obstruct the flow path.

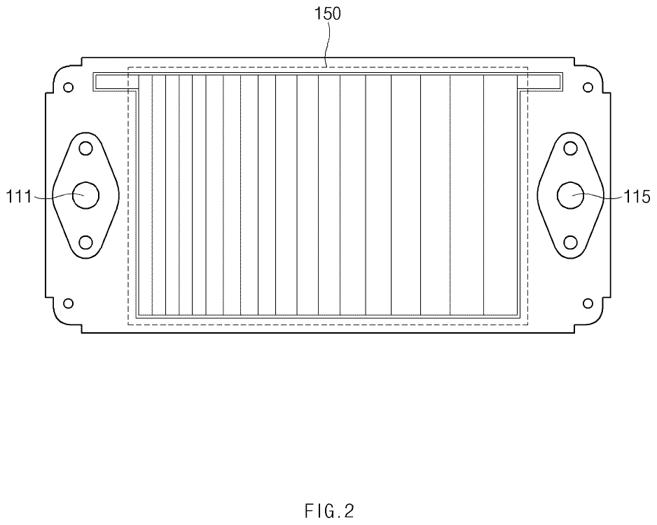

Accordingly, the heating member of the heat exchanger 100 according to an embodiment of the present disclosure is configured with a heating pattern 150 for preventing scales from being generated, by suppressing a continuous rise in the surface temperature of the water. Accordingly, a detailed configuration of the heating member will be described with reference to the embodiment of FIG. 2.

FIG. 2 is a view illustrating a configuration of a heating member according to an embodiment of the present disclosure. Referring to FIG. 2, the heating member may be formed between the water inlet 111 and the water outlet 115, and the heating pattern 150 may be formed at a central position thereof. Electrodes may be connected to opposite ends of the heating pattern 150 so that electric power may be applied to the heating pattern 150 through the electrodes.

The heating pattern 150 may consist of a plurality of resistors. Here, the plurality of resistors may be connected in a series structure or a parallel structure, and may be connected in a structure, in which a series structure and a parallel structure are combined. At this time, the heating pattern 150 may be formed in a zigzag shape, but is not limited thereto. Here, the zigzag shape means a shape that reciprocates in a leftward/rightward direction that is perpendicular to a reference direction when the directions of the water inlet 111 and the water outlet 115 are determined as a reference direction.

To prevent the scales from being generated in the flow path of the heat exchanger 100, it is necessary to suppress the continuous rise in the surface temperature of the water. The surface temperature of the water may be defined as illustrated in [Equation 1] below.

$${T}_{1} = {T}_{0} + Δ T = {T}_{0} + \frac{q}{h} \qquad [ Equation 1 ]$$

In [Equation 1], T1 denotes the surface temperature of water, T₀ denotes a deep part temperature of the water, “q” denotes a power density, and “h” denotes a heat transfer coefficient. As illustrated in [Equation 1], because the surface temperature of the water is proportional to the power density, it is possible to suppress the continuous rise in the surface temperature of water by decreasing the power density.

Here, the power density may be defined as in [Equation 2] below.

$$q ∝ \frac{{I}^{2} {R}_{0}}{{w}^{2}} \qquad [ Equation 2 ]$$

In Equation 2, “q” means the power density, “I” means the current, R₀ means a total resistance, and “w” means a width of the heating pattern 150. Here, the width of the heating pattern 150 means a width, in the reference direction, of the heating pattern formed long in the longitudinal direction when directions of the water inlet 111 and the water outlet 115 are set as the reference direction, and a leftward/rightward direction that is perpendicular to the reference direction is set as a lengthwise direction. As in Equation 2, because the power density is inversely proportional to the square of the width of the heating pattern 150, the power density may be decreased when the width of the heating pattern 150 is increased.

Accordingly, by increasing the width of the heating pattern 150 of the heating member for each section, the power density may be decreased step by step, and thus, the surface temperature of the water may be suppressed from continuously rising. Accordingly, it becomes possible to prevent the scales from being generated in the flow path of the heat exchanger 100.

Here, the heating pattern 150 of the heating member may be formed in a zigzag pattern, and the power density may be finely adjusted by changing the width of the heating pattern 150 for each line in the zigzag pattern.

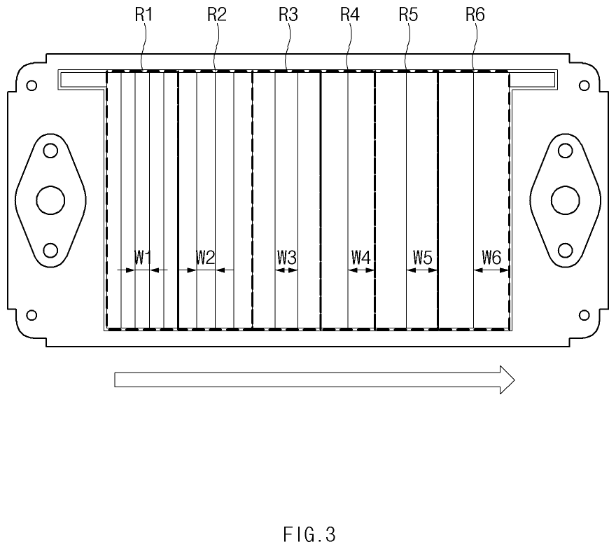

To this end, the heating pattern 150 may be divided into a predetermined section unit, and the width of the heating pattern 150 may be adjusted for each of the divided sections. It is preferable to decrease the power density step by step for each section by forming the width of the heating pattern 150 such that it becomes gradually larger as it goes from the water inlet 111 toward the water outlet 115. FIG. 3 will be referenced for the embodiment.

FIG. 3 is a view illustrating an embodiment of subdividing a heating pattern of a heating member for each section according to an embodiment of the present disclosure. Referring to FIG. 3, the heating pattern 150 of the heating member is formed in a zigzag shape, and may be divided into “N” sections.

As an example, the heating pattern 150 of the heating member may be divided into six sections R1 to R6, as illustrated in FIG. 3. Of course, this is only an example, and may be divided into less than six or six or more sections depending on the embodiment. Here, the first section may be a section that is adjacent to the water inlet 111, and the sixth section may be a section that is adjacent to the water outlet 115.

The first section is the first divided section, and the width of the heating pattern 150 may be formed as much as w1. The second section is the second divided section, and the width of the heating pattern 150 may be formed as much as w2 that is greater than w1. The third section is the third divided section, and the width of the heating pattern 150 may be formed as much as w3 that is greater than w2. The fourth section is the fourth divided section, and the width of the heating pattern 150 may be formed as much as w4 that is greater than w3. The fifth section is the fifth divided section, and the width of the heating pattern 150 may be formed as much as w5 that is greater than w4. Similarly, the sixth section is the sixth divided section, and the width of the heating pattern 150 may be formed as much as w6 that is greater than w5.

In this way, when the power pattern is divided into six sections and the width of the heating pattern 150 is gradually increased for each section, the power density gradually decreases as it goes from the first section to the sixth section.

For example, when the width of the heating pattern 150 in the first section is w1=7.2 mm, the power density is 527,000 W/m², whereas when the width of the heating pattern 150 in the sixth section is w6=10.4 mm, the power density is 246,000 W/m². Accordingly, it becomes possible to prevent scales from being generated in the flow path as the surface temperature of the water that flows along the flow path in the interior of the body part of the heat exchanger 100 decreases due to the decrease in power density.

Here, because the heating member according to the present disclosure may reduce the power density only by adjusting the width of the heating pattern 150 for each divided section, no additional electrode is required to decrease the power density. Accordingly, no additional facilities are required to prevent scales from being generated in the flow path in the heat exchanger 100, and scales may be prevented from being generated in the flow path while the costs are prevented from increasing due to the additional facilities.

Here, the heating pattern 150 may consist of a plurality of resisters, and each of the resistors may be connected in a series structure or a parallel structure, or a combined structure of series and parallel structures.

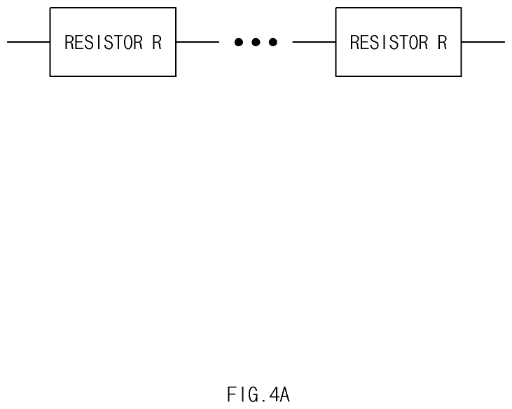

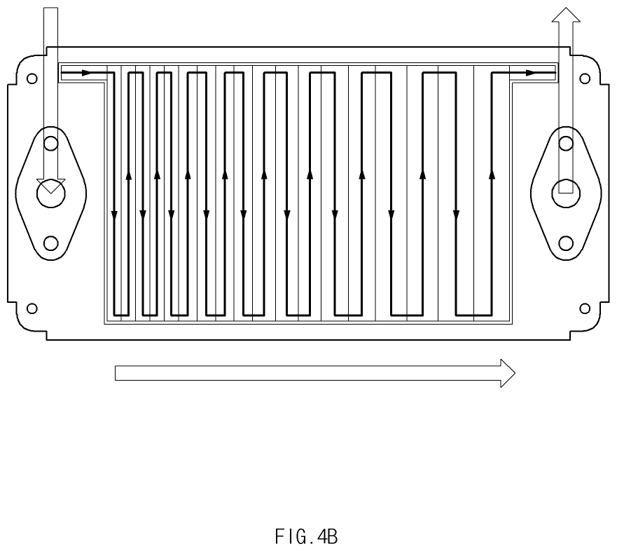

Accordingly, a connection structure of the heating pattern 150 will be described with reference to the embodiments of FIGS. 4A to 6C.

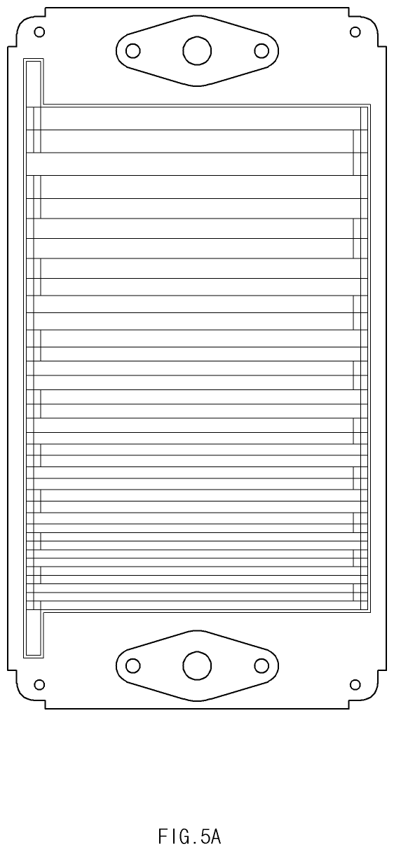

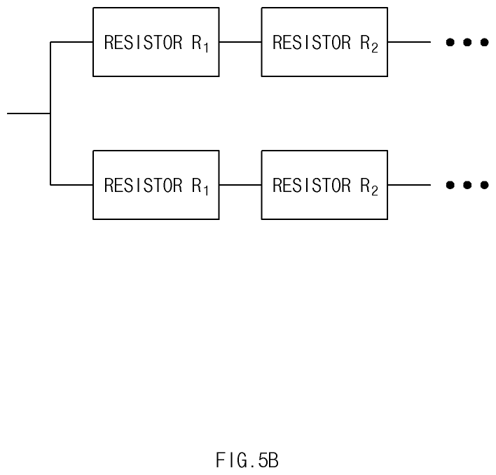

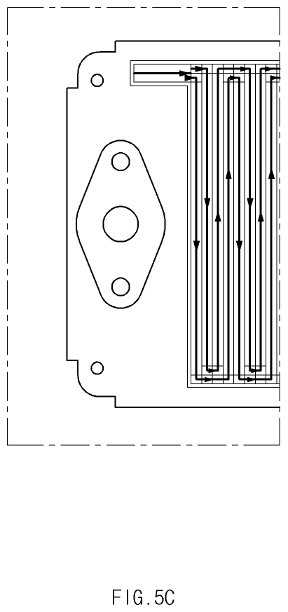

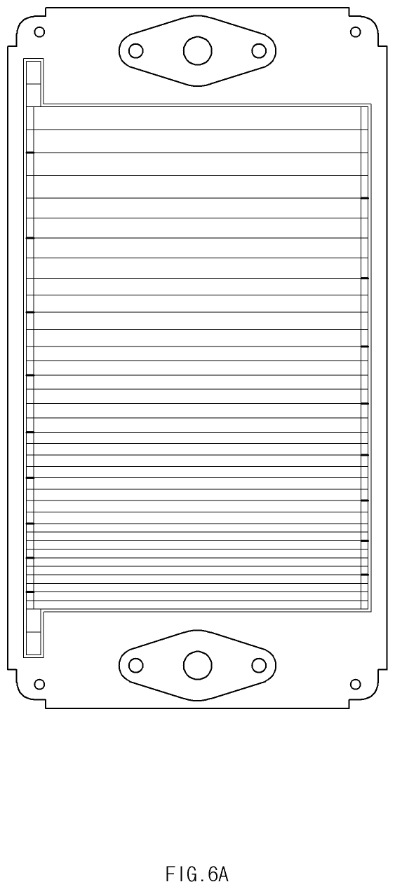

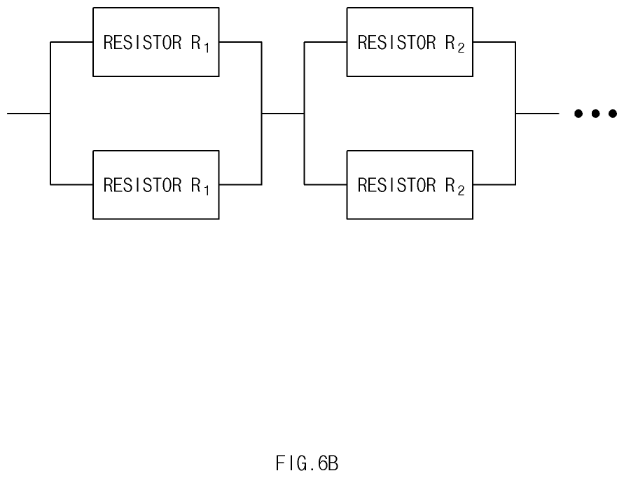

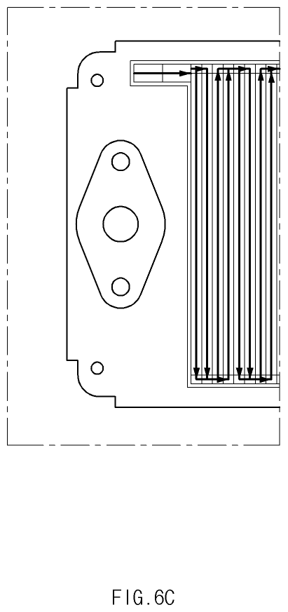

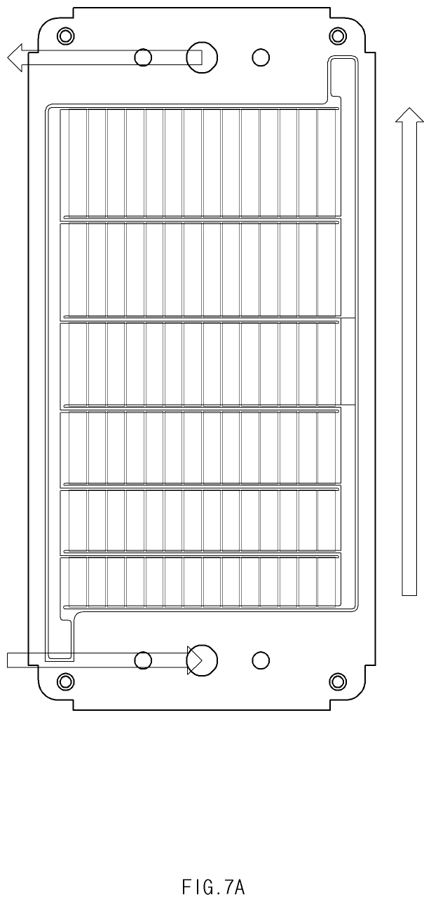

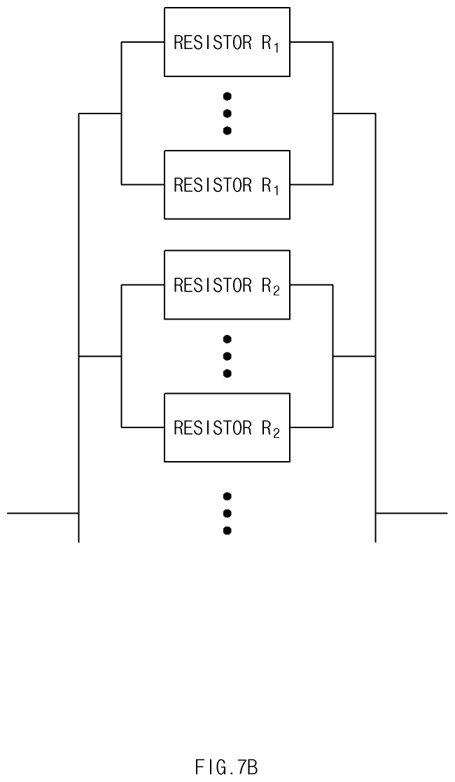

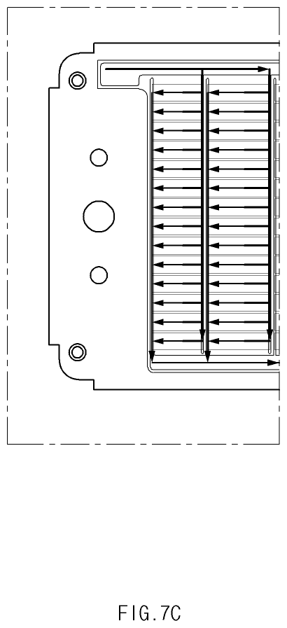

FIGS. 4A and 4B are views illustrating a structure of a heating pattern according to a first embodiment of the present disclosure, FIGS. 5A, 5B, and 5C are views illustrating a structure of a heating pattern according to a second embodiment of the present disclosure, FIGS. 6A, 6B, and 6C are views illustrating a structure of a heating pattern according to a third embodiment of the present disclosure, and FIGS. 7A, 7B, and 7C are views illustrating a structure of a heating pattern according to a fourth embodiment of the present disclosure.

First, referring to FIGS. 4A and 4B, the heating pattern 150 according to the first embodiment may be implemented in a form, in which a plurality of resistors is connected in a series structure. When the heating pattern 150 is connected in a series structure as in the first embodiment, because a width for each line of the heating pattern 150 formed in a zigzag may be adjusted, it becomes possible to subdivide the power density by the number of lines of the heating pattern 150 and decrease it step by step.

First, referring to FIGS. 5A, 5B, and 5C, the heating pattern 150 according to the second embodiment may be implemented in a form, in which a plurality of resistors is connected in a parallel structure. When the heating pattern 150 is connected in a parallel structure as in the second embodiment, because a width for each pair of lines of the heating pattern 150 formed in a zigzag may be adjusted, it becomes possible to subdivide the power density by the number of the pairs of lines of the heating pattern 150 and decrease it step by step.

In this way, when the heating pattern 150 is connected in a parallel structure, a current stress may be decreased because a current applied to the heating pattern 150 is to a half of the total current.

First, referring to FIGS. 6A, 6B, and 6C, the heating pattern 150 according to the third embodiment may be implemented in a form, in which a plurality of resistors is connected in a combined structure of series and parallel structures. When the heating pattern 150 is connected in a series/parallel combination structure as in the third embodiment, because a width for each pair of lines of the heating pattern 150 formed in a zigzag may be adjusted, it becomes possible to subdivide the power density by the number of the pairs of lines of the heating pattern 150 and decrease it step by step.

In this way, when the heating pattern 150 is connected in the series/parallel combination structure, an output is possible through another line even when any one of the pairs of the lines of heating patterns 150 connected in parallel is damaged.

Referring to FIGS. 7A, 7B, and 7C, the heating pattern 150 according to the fourth embodiment may be implemented in a form, in which a plurality of resistors is connected in a combined structure of parallel structures, that is, a parallel/parallel combination structure. As in the fourth embodiment, when the heating pattern 150 is connected in the parallel/parallel combination structure, a resistance is determined by a length of a heater due to the characteristics of the parallel connection.

Accordingly, the resistance increases as the heating pattern 150 is formed such that the length of the heater increases as it goes from the water inlet to the water outlet, and thus, the power density decreases step by step.

The power density according to the fourth embodiment may be defined as in [Equation 3] below.

$$q ∝ \frac{{V}^{2}}{{l}^{2} {R}_{0}} \qquad [ Equation 3 ]$$

In Equation 2, “q” means the power density, “V” means a voltage, R₀ means a total resistance, and “I” means a length of the heating pattern 150. Here, the length of the heating pattern 150 means a length of the heating pattern in a direction that is perpendicular to the reference direction when the directions of the water inlet 111 and the water outlet 115 are determined as the reference direction. As in Equation 3, because the power density is inversely proportional to the square of the length of the heating pattern 150, the power density may be decreased when the length of the heating pattern 150 is increased.

In this way, when the heating pattern 150 is connected in the parallel/parallel combination structure, the current stress decreases compared to the serial type as the current applied to the heating unit decreases due to the parallel connection.

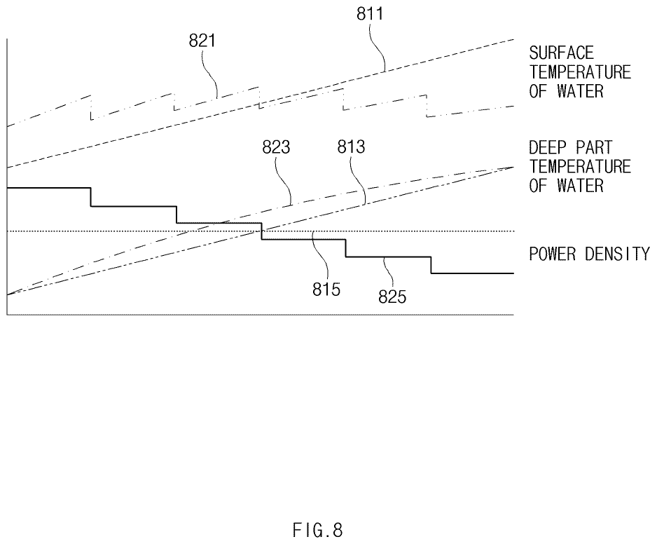

In the heating pattern 150 according to the first to fourth embodiments, the power density is gradually decreased as a line width of the heating pattern 150 gradually increases for each section as it goes from the water inlet 111 to the water outlet 115, and thus, it is possible to prevent scales from being generated in the flow path by suppressing a continuous increase in the surface temperature of water that flows along the flow path. A change in the state of the heat exchanger due to the adjustment of the width of the heating pattern 150 of the heating member may be expressed as in FIG. 8.

FIG. 8 is a view illustrating a change in a state of a heat exchanger according to an embodiment of the present disclosure. Referring to FIG. 8, reference numerals 811, 813, and 815 denote changes in the state before the width of the heating pattern 150 is adjusted, reference numerals 811 denotes the surface temperature of the water, reference numeral 813 denotes a deep part temperature of the water, and reference numeral 815 denotes a change in the power density.

Before the width of the heating pattern 150 is adjusted, because the power density of the heating pattern 150 is continuously maintained as in the reference numeral 815, the surface temperature of the water gradually rises.

Accordingly, as the surface temperature of water continues to rise, as in reference numeral 811, scales, in which calcium ions are deposited as calcium carbonate on the surface of water, may be generated.

Meanwhile, reference numerals 821, 823, and 825 denote changes in the state after the width of the heating pattern 150 is adjusted, reference numerals 821 denotes a change in the surface temperature of the water, reference numeral 823 denotes a deep part temperature of water, and reference numerals 825 denotes the power density.

In an embodiment of the present disclosure, by dividing the heating pattern 150 into six sections and adjusting the width of the heating pattern 150 for each section such that they become gradually larger, as in reference numerical 825, the power density of the heating pattern 150 for each section gradually decreases, and thus, the surface temperature of the water decreases for each section.

As a result, as in reference numerical 821, the surface temperature of the water decreases for each section. In this case, because the power density is maintained the same in the same section, the surface temperature of the water gradually increases, but when in the next section, because the power density decreases, the surface temperature of the water partially decreases.

In this way, in the heat exchanger 100 according to an embodiment of the present disclosure, by gradually decreasing the power density for each section of the heating pattern 150, it is possible to prevent the surface temperature of the water from continuously rising, and thus, a maximum surface temperature of the water may be prevented from exceeding a predetermined temperature, and accordingly, it is possible to prevent scales from being generated on the surface of the water in the flow path.

The heat exchanger 100 configured as described above may be configured to be included in a water heating apparatus, such as an electric boiler or a water heater.

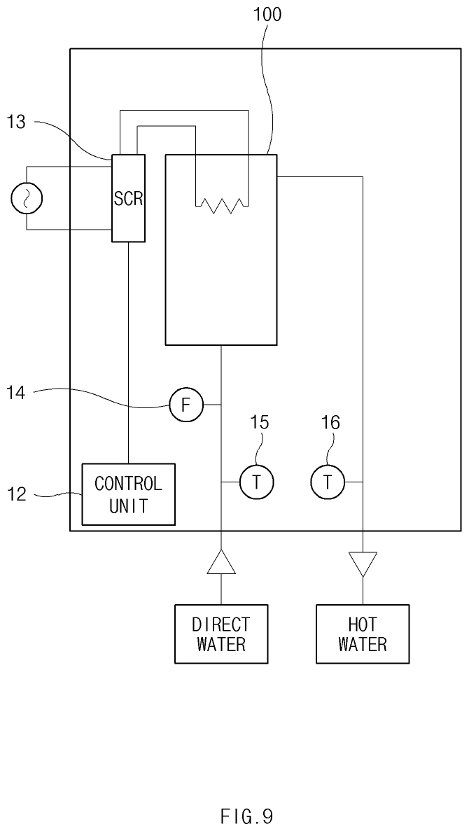

Accordingly, the configuration of the water heating apparatus including the heat exchanger according to an embodiment of the present disclosure will be described with reference to an embodiment of FIG. 9.

FIG. 9 is a view illustrating a water heating apparatus according to an embodiment of the present disclosure. Referring to FIG. 9, a water heating apparatus 10 may correspond to an electric boiler or a water heater that stores and heats water.

Accordingly, the water heating apparatus 10 may include a control unit 12 and a thyristor 13 that is configured to receive current from an external power source, supply it to a heating means that heats water, and control on/off of supply of the current by the control unit 12. Furthermore, the water heating apparatus may further include a heat exchanger 100.

The heat exchanger 100 may generate direct water of a room temperature that is supplied through the direct water supply line as hot water by exchanging heat with the direct water, and may discharge the generated hot water to hot water discharge line. Here, a detailed configuration of the heat exchanger 100 will be described with reference to the embodiments of FIGS. 1A to 8 described above.

Then, the direct water supply line may be provided with a temperature sensor 15 for measuring the temperature of the supplied direct water, and a flow velocity sensor 14 for measuring an amount of the supplied direct water, and the hot water discharge line may be further provided with a temperature sensor 16 for measuring the temperature of the discharged hot water.

The configuration of the water heating apparatus illustrated in FIG. 9 is an embodiment, and the other configurations except for the heat exchanger may be modified according to an embodiment.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

1. A heat exchanger comprising:
a heating member including a heating pattern of a predetermined shape, the heating pattern being configured to generate heat; and
a body part configured to exchange the heat generated by the heating member to generate and discharge hot water while water introduced through a water inlet flows to a water outlet along a flow path,
wherein the heating pattern is divided into a plurality of sections, and is formed such that widths of the heating pattern are different for the divided sections.

2. The heat exchanger of claim 1, wherein the heating pattern is formed along a flow direction of the water flowing along the flow path.

3. The heat exchanger of claim 2, wherein the heating pattern is formed in a zigzag shape.

4. The heat exchanger of claim 1, wherein the body part includes:
an upper panel, in which the water inlet and the water outlet are formed;
a lower panel coupled to the upper panel at a lower portion of the upper panel; and
a flow path panel, in which the flow path is formed, and formed to be adhered between the upper panel and the lower panel when the upper panel and the lower panel are coupled to each other, and
wherein the flow path panel is formed such that ends of the flow path is connected to the water inlet and the water outlet.

5. The heat exchanger of claim 4, wherein the heating member is formed to be adhered to an upper portion of the upper panel, and is formed between the water inlet and the water outlet.

6. The heat exchanger of claim 4, wherein the heating pattern is formed such that the widths of the heating pattern become gradually larger as they go from the water inlet connected to the flow path to the water outlet.

7. The heat exchanger of claim 6, wherein the heating pattern is formed such that the widths of the heating pattern become gradually larger for the divided sections, and the widths of the heating pattern are the same in the same section.

8. The heat exchanger of claim 6, wherein the heating pattern is formed such that power densities thereof decrease as they go from the water inlet connected to the flow path of the heat exchanger to the water outlet, for the divided sections.

9. The heat exchanger of claim 1, wherein the heating pattern includes a plurality of resistors, and the plurality of resistors is connected in a series structure.

10. The heat exchanger of claim 1, wherein the heating pattern includes a plurality of resistors, and the plurality of resistors is connected in a parallel structure.

11. The heat exchanger of claim 1, wherein the heating pattern includes a plurality of resistors, and the plurality of resistors is connected in a combined structure of series and parallel structures.

12. The heat exchanger of claim 1, wherein the heating pattern includes a plurality of resistors, and the plurality of resistors is connected in a combined structure of parallel structures.

13. The heat exchanger of claim 1, wherein the heating member further includes:
an insulation pad formed to be attached to an upper portion and a lower portion of the heating pattern.

14. A water heating apparatus including the heat exchanger of claim 1.
